(19) United States
(12) Patent Application Publication
(10) Pub. No.: US 2005/0127556 A1
(43) Pub. Date: Jun. 16, 2005

(54) Process for the preparation of conducting polymer moulding compound with improved processability

(76) Inventors: Subramaniam Radhakrishnan, Pune (IN); Valiyavalappil Sreejith, Pune (IN)

Correspondence Address: LUEDEKA, NEELY & GRAHAM, P.C., P O BOX 1871, KNOXVILLE, TN, 37901, US

(21) Appl. No.: 10/736,208

(22) Filed: Dec. 15, 2003

(51) Int. Cl. B29C 47/00

(52) U.S. Cl. 264/148

(57) ABSTRACT

Conducting polymers are required for many applications in electrical and electronic industry such as RF/EMI shielding, electrostatic protection etc. wherein their shaping and moulding by conventional techniques is desired. The method of incorporation of carbon black or metal particles to make conducting polymer composite has many drawbacks regarding melt flow and processability. In order to make intrinsically conducting polymer blends which are melt processable, modified doping agents have to be used. Even in such cases, the process is more suitable for solution blending/casting rather than melt processing. In order to overcome many of these drawbacks it is essential to synthesize the conducting polymer compound in such manner that it provides high electrical conductivity as well as good melt flow properties. The present invention provides a novel method of incorporation of the doping agent in the conducting polymer in another polymer matrix together with a dispersing agent which leads to improved processability for the moulding compound.

This invention relates to a process for preparation of conducting polymer moulding compound with improved processability. More particularly it relates to preparation of conducting polymer blends which have high electrical conductivity and which are moldable by melt processing methods.

Conducting polymers are important materials for electrical and electronic industries due to large variety of applications such as RF/EMI shielding, antistatic properties etc. The conventional conducting polymers which can be moulded are made as composites by dispersing conducting particles such as metal powders, carbon black, graphite etc. in thermoplastics (HDPE, PVC, PET, Nylon etc. Ref. E. Sichel, Carbon Black Polymer Composites, Marcel Dekker N.Y., 1982) However, the concentration of the conducting particles in these composites has to be very high (>30%) for obtaining sufficient level of conductivity. At such high concentrations of the conducting particle additive, the melt viscosity increases tremendously and this causes many difficulties in melt processing of these materials. Intrinsically conducting polymers (ICP) such as polyaniline, polypyrrole etc. are not melt processable by themselves since there is no well defined melting or melt flow for these type of polymers (H. Nalwa, Handbook of Conductive Molecules and Polymers, J. Wiley N.Y. 1997). Further, there is a great loss of conductivity for these ICP at high processing temperatures. Hence it is essential to develop conducting polymer compounds which are stable as well as easily melt processable. The prior art for the preparation of conducting polymer which can be melt or solution processed as described in the patents (U.S. Pat. No. 5,928,565, dt.7/1999, WO 9010297, dt.9/1990, U.S. Pat. No. 5,002,700 dt.3/1991) mainly consists of preparation of polyaniline in hydrochloric acid as emeraldine salt, dedoping or neutralizing the same with ammonia, drying the powder to give emeraldine base polyaniline, mixing it with a solvent and doping agent chosen from sulfonic acid derivatives and then blending it with other polymers to give processable conducting polymer blend. The process described in U.S. Pat. No. 5,928,565, dt.7/1999, is also essentially same but for the fact that the doping of emaraldine base polyaniline with sulfonic acid is carried out high temperature and then it is melt compounded with other thermoplastics. There are thus large number of steps described in the prior art, which make these processes very cumbersome and do not lead to very high conductivity (electrical resistance in the range of 100 K ohm-cm) at reasonable composition (<40% polyaniline) or ease of processing.

The objective of this invention is to provide a process for preparation of conducting polymer moulding compound which has high electrical conductivity as well as melt flow properties. Another objective of the present invention is to provide a process which comprises less number of unit operations to prepare the final product.

Accordingly, the present invention provides a process for preparation of conducting polymer moulding compound with improved processability which comprises dissolving a doping agent and a monomer in pure solvent, cooling the same to temperature ranging from 2° C. to 5° C., adding drop wise an oxidizing agent under agitation, allowing the reaction mixture to remain at temperature ranging from 2° C. to 35° C. for a period ranging from 4 hours to 10 hrs, precipitating the polymer by dumping the reaction mixture in distilled water and separating the polymer by conventional methods, drying the polymer powder to obtain conducting polyaniline (I), adding (I) to another polymer with low melting point and a dispersing agent, melt extruding the mixture at temperature in the range of 100 to 150° C., quenching the extrudate and cutting it to suitable size in the range of 3 to 5 mm to give melt processable conducting polymer compound which can be moulded into different shapes by conventional techniques.

In an embodiment of the present invention, the oxidizing agent contains electron withdrawing groups and may be selected from alkali metal salts with dichromate, persulfate and perchlorate ions, benzoyl peroxide and ferric chloride.

In another embodiment of the present invention, the oxidizing agent used is in concentration range of 0.1 molar to 2 molar, preferably 1.1 molar ofthe reactant.

In another embodiment of the present invention, the doping agent is chosen from substituted sulfonic, phosphoric and carboxylic acids containing alkyl chain with more than 6 carbon atoms.

In yet another embodiment of the present invention, the solvent used contains polar groups and has high dielectric constant more than 40 and is chosen from solvents such as water, n-methyl pyrrolidone, di-methyl sulfoxide, di-methyl formamide, acetonitrile and methanol or mixtures therof.

In another embodiment, the monomer used may be aromatic compounds containing nitrogen such as aniline or substituted aniline, anisidine, toluidine and their substituted derivatives in the concentration range of 0.01 to 0.5 mol preferably 0.1 to 0.2 mol.

In another embodiment of the present invention, the second polymer having low melting point has more than two branch points per 1000 units and is chosen from polymers like low density polyethylene, linear low density polyethylene, atactic polypropylene and their co-polymers with butadiene, acrylate, styrene elastomers and rubbers.

In yet another embodiment of the present invention, the dispersing agent contains ether, acetate or hydroxyl groups and weight average molecular weight in the range of 4000 to 1,30000 preferably between 32000 to 64000.

In a feature of the present invention, the melt flow index of the conducting polymer compound is in the range of 0.4 to 15 g/10 min which is suitable for moulding by melt processing techniques.

The process of the present invention is described hereinbelow with examples, which are illustrative only and should not be construed to limit the scope of the invention in any manner.

### EXAMPLE-1

Dodecyl benzene sulfonic acid 7.1 ml was dissolved in 500 ml pure distilled water to which were then added 2.0 ml aniline monomer and cooled to 2° C. using freezing mixture. Ammonium persulfate (5.3 g) was dissolved separately in 100 ml distilled water and stirred for 15 minutes was cooled to 5° C. This was then added drop wise to the monomer solution with stirring. The whole reaction mixture was maintained at 2 to 5 oC for 10 hrs. when the solution was found to become viscous dark green. The doped conducting polyaniline formed (I) was coagulated with potassium chloride (10 gm) and the powder was precipitated by dumping the reaction mixture in 500 ml distilled water, followed by filtration and drying by conventional methods. 3 g of the powder was added to low density polyethylene (melting point 109 C) 10 g to which were added 0.5 g polyethylene oxide (molecular weight 300000). The whole mixture was then melted and extruded at 150 C through 2 mm die to obtain strands of conducting polymer blend. These were cut to 3 to 5 mm long pieces which could be melt processed to form sheet, films etc. The properties of this conducting polymer moulding compound are given in Table-1.

### EXAMPLE-2

The doped conducting polyaniline (I) was prepared by the process as described in example-1. 4 g of the (I) powder was added to 6 g of low density polyethylene to which were added 0.3 g polyethylene oxide (molecular weight 300000). The whole mixtuxe was melted and extruded at 150 C through 2 mm die to form strands which were then air cooled and cut to size of 3 mm to 5 mm length. These were then compression moulded to form films. The properties of the conducting polymer moulding compound are given in Table-1.

### EXAMPLE-3

The doped conducting polyaniline (I) was prepared by the process as described in example-1. 4 g of the (I) powder was added to 6 g of polyethylene to which were added 0.5 g polyethylene glycol (average molecular weight 32000). The whole mixture was melted and extruded at 150 C through 2 mm die to form strands which were cooled and then cut to 3 mm to 5 mm length. These were then compression moulded to form sheets. The properties of this conducting polymer moulding compound are given in Table-1.

### EXAMPLE-4

The doped conducting polyaniline (I) was prepared by the process as described in example-1 of this invention. 4 g of the (I) powder was added to 6 g of low density polyethylene (0.9 g/cc) and the whole mixture was melted and extruded at 130 C through 2 mm die to form strands which were cooled and then cut to 3 mm-5 mm length. These were then compression moulded to form sheets. The properties of this conducting moulding compound are given in Table-1.

TABLE 1
Data on conducting polymer moulding compounds

| Example | Resistivity of sheet * | Melt Flow Index |
|---|---|---|
| Number | (ohm-cm) | 125° C., 5 Kg load |
| 1 | 0.96 × 10³ | 0.97 |
| 2 | 0.04 × 10³ | 0.87 |
| 3 | 0.34 × 10³ | 0.48 |
| 4 | 0.39 × 10³ | 0.28 |
| (without processing agent) | | |
| Conventional Conducting | 0.62 × 10³ | 0.035 |
| Polymer Compound | | |
| containing carbon black ** | | |
| Original polyethylene | >1.3 × 10¹⁴ | 0.865 |
| without modification | | |

* The sheet is made by compression moulding the compound at 130° C. at 3 ton pressure for min and then quenching by water.
** conducting particles (acetylene black or graphite) 15% by wt. of same grade of polyethylene used in the examples 1 to 4 and melt extruded and processed as above.

The above observations in Table-1 clearly indicate that the conducting polymer moulding compounds prepared by the process described in this invention have much more melt flow (even better than the original polyethylene) as well as conductivity than those prepared by conventional method of addition of conducting carbon black. It can also be noted that the at certain composition of the blend containing dispersing agent the electrical resistance is very low or conductivity very high and at the same composition the melt flow is much better than that without the dispersing agent (example-4).

The main advantage of the present invention is that the conducting polymer moulding compound can be made in any shape and size by conventional melt processing techniques such as compression moulding, extrusion, transfer moulding etc. at lower temperatures since the melt flow properties are improved. The electrical conductivity also is retained to high level in the compound even after melt processing which is not the case for earlier reported data.

1. A process for preparation of conducting polymer moulding compound moulding compound with improved processability which comprises dissolving a doping agent and a monomer in pure solvent, cooling the same to temperature ranging from 2° C. to 5° C., adding drop wise an oxidizing agent under agitation, allowing the reaction mixture to remain at temperature ranging from 2° C. to 35° C. for a period ranging from 4 hours to 10 hrs, precipitating the polymer by dumping the reaction mixture in distilled water and separating the polymer by conventional methods, drying the polymer powder to obtain conducting polyaniline (I), adding (I) to another polymer with low melting point and a dispersing agent, melt extruding the mixture at temperature in the range of 100 to 150° C. quenching the extrudate and cutting it to suitable size in the range of 3 to 5 mm to give melt processable conducting polymer compound which can be moulded into different shapes by conventional techniques.

2. A process as claimed in claim 1 wherein, the oxidizing agent contains electron withdrawing groups and may be selected from compounds with dichromate, persulfate and perchlorate ions, benzoyl peroxide and ferric chloride.

3. A process as claimed in claim 1 wherein, the oxidizing agent used is in concentration range of 0.1 molar to 2 molar ratio, preferably 1.1 molar of the reactant concentration.

4. A process as claimed in claim 1 wherein, the doping agent is chosen from substituted sulfonic, phosphoric and carboxylic acids containing alkyl chain with more than 6 carbon atoms.

5. A process as claimed in claim 1 wherein, the solvent used contains polar groups and has high dielectric constant more than 40 and is chosen from solvents such as water, n-methyl pyrrolidone, di-methyl sulfoxide, di-methyl formamide, acetonitrile and methanol or mixtures therof.

6. A process as claimed in claim 1 wherein, the monomer used may be aromatic compounds containing nitrogen such as aniline or substituted aniline, anisidine, toluidine and their substituted derivatives in the concentration range of 0.01 to 0.5 mol. preferably 0.1 to 0.2 mol.

7. A process as claimed in claim 1 wherein, the second polymer having low melting point has more than two branch points per 1000 units and is chosen from polymers like low density polyethylene, linear low density polyethylene, atactic polypropylene and their co-polymers with butadiene, acrylate, styrene elastomers and rubbers

8. A process as claimed in claim 1 wherein, the dispersing agent contains ether, acetate or hydroxyl groups and weight average molecular weight in the range of 4000 to 1,30000 preferably between 32000 to 64000.

9. A process as claimed in claim 1 wherein, the melt flow of the conducting polymer compound is in the range of 0.4 to 15 g/10 min which is suitable for moulding by melt processing techniques.
